(19) United States
(12) Patent Application Publication
(10) Pub. No.: US 2010/0175319 A1
(43) Pub. Date: Jul. 15, 2010

(54) PLANT HYDRATION PALLET TRAY

(76) Inventor: Michael Meeks, Forest City, NC (US)

Correspondence Address: ROETZEL & ANDRESS, 1375 EAST 9TH STREET, CLEVELAND, OH, 44114, US

(21) Appl. No.: 12/352,086

(22) Filed: Jan. 12, 2009

(51) Int. Cl. A01G 25/16; A47G 7/02

(52) U.S. Cl. 47/79; 47/39

(57) ABSTRACT

A plant hydration pallet tray for supporting, hydrating, transporting and displaying several potted plants in a commercial/retail environment, has a generally rectangular base and side walls form a generally cubic structure for supporting plants in pots or containers and providing controlled drainage of water from the potted plants and from the tray to maintain optimum hydration of the plants on the tray.

### FIELD OF THE INVENTION

The present disclosure relates generally to a tray, more particularly to a plant hydration and pallet tray (also referred to herein as “plant tray” and “plant pallet tray”) for supporting, hydrating, storing, transporting and draining one or more potted plants in a commercial/retail environment.

### BACKGROUND OF THE INVENTION

Potted plants as sold at retail or wholesale are easily dehydrated due to lack of water over a sustained period of time. It is difficult to keep a large number of potted plants sufficiently watered so that they will not die or become damaged due to lack of water. Potted plants are usually displayed in the outdoors where the sun can dry them out quickly if not continuously watered. It is also time consuming as each plant must be separately watered. This problem may result in a large number of ailing plants that must be discounted or worse, a number of dead plants that become a complete loss. Pots which are used for plant transport from nursery to sale are generally configured to be as compact as possible while still allowing for some root growth, water absorption and drainage. The amount of soil in the pot is minimized, which sharply increases the possibility of harmful dehydration, and requires close monitoring and regular watering to avoid dehydration. Placing pots upon pallets for transport and display can actually increase the rate of dehydration by exposing the bottoms of the pots, where the most dense root structures are located, to open air. Watering only from above does not efficiently restore moisture to the bottoms of the pots on a pallet.

### SUMMARY OF THE INVENTION

A plant hydration pallet tray for storing, watering, transporting and displaying potted plants at retail or wholesale, includes a base with four sidewalls, one or more openings in the base used to drain water, one or more ribs arranged diagonally across the base, one or more gussets arranged at an angle between the base and side walls, and a lip that extends outward and runs along each side wall. The plant trays have average drainage rates in an approximate range of three to six hours.

### DESCRIPTION OF THE DRAWINGS

FIG. 1 is a perspective view and enlarged section thereof of one embodiment of a plant tray of the disclosure and related inventions;

FIG. 2 is a plan view of one embodiment of a plant tray of the disclosure and related inventions;

FIG. 3 is an elevation view of the plant tray of FIGS. 1 and 2; and

FIG. 4 is a drawing of the plant tray of FIGS. 1 through 3 attached via pallet ties to a pallet.

### DETAILED DESCRIPTION OF PREFERRED AND ALTERNATE EMBODIMENTS

The specific dimensions of the plant tray are determined by tray dimensions and drainage hole number, size and placement which are designed to effect the optimal gravity induced drain rate of water from the plant tray, in conjunction with the drain rates of the pots and loss of moisture to the atmosphere.

The plant type and container or pot size, tray size, hole pattern, hole quantity, and hole size are set to achieve optimal water retention in potted plants placed on the tray, and to avoid dehydration. Each variable was varied in each iteration of testing and the resulting data was analyzed to determine each plant tray specification which will be discussed herein.

The following table sets forth representative parameters and dimensions for various embodiments of the plant trays of the disclosure and related inventions.

| Tray | Plant | Container | Hole | Hole | Hours to |
|---|---|---|---|---|---|
| Number | Type | Size | Quantity | Size | Drain |
| 1 | Dianthus | 1 g | 2 | ⅛ | 3 |
| | Boxwood | 3 g | 2 | ⅛ | 3 |
| | Azalea | 5 g | 2 | ⅛ | 3 |
| 2 | Dianthus | 1 g | 2 | ⅛ | 7 |
| | Boxwood | 3 g | 2 | ⅛ | 7 |
| | Azalea | 5 g | 2 | ⅛ | 7 |
| 3 | Dianthus | 1 g | 2 | ⅛ | 10 |
| | Boxwood | 3 g | 2 | ⅛ | 10 |
| | Azalea | 5 g | 2 | ⅛ | 10 |
| 4 | Dianthus | 1 g | 2 | ⅛ | 12.5 |
| | Boxwood | 3 g | 2 | ⅛ | 12.5 |
| | Azalea | 5 g | 2 | ⅛ | 12.5 |
| 5 | Dianthus | 1 g | 3 | ⅛ | 3.5 |
| | Boxwood | 3 g | 3 | ⅛ | 3.5 |
| | Azalea | 5 g | 3 | ⅛ | 3.5 |
| 6 | Dianthus | 1 g | 4 | ⅛ | 2 |
| | Boxwood | 3 g | 4 | ⅛ | 2 |
| | Azalea | 5 g | 4 | ⅛ | 2 |
| 7 | Dianthus | 1 g | 8 | ⅛ | 1 |
| | Boxwood | 3 g | 8 | ⅛ | 1 |
| | Azalea | 5 g | 8 | ⅛ | 1 |
| 8 | Dianthus | 1 g | 4 | 3/32 | 6 |
| | Boxwood | 3 g | 4 | 3/32 | 6 |
| | Azalea | 5 g | 4 | 3/32 | 6 |
| 9 | Dianthus | 1 g | 4 | 3/32 | 7 |
| | Boxwood | 3 g | 4 | 3/32 | 7 |
| | Azalea | 5 g | 4 | 3/32 | 7 |
| 10 | Scabiosa | 1 g | 4 | 3/32 | 8 |
| | Boxwood | 3 g | 4 | 3/32 | 8 |
| | Apple | 5 g | 4 | 3/32 | 8 |
| 11 | Scabiosa | 1 g | 4 | 3/32 | 9 |
| | Boxwood | 3 g | 4 | 3/32 | 9 |
| | Apple | 5 g | 4 | 3/32 | 9 |

As the data indicates, the drain rate for each plant tray combination varies from approximately 1 hour to 12.5 hours. The plant trays are configured to achieve the combination of optimal drain rate which maintains adequate or ideal moisture content and avoids over-hydration. In accordance with the disclosure and related inventions, approximate drain rates of between three to six hours are preferred. For example, drainage tray 1, having two ⅛^{th} inch drainage holes, has a drainage rate of approximately three hours. Drainage tray 5, having three ⅛^{th} inch drainage holes, has a drainage rate of approximately 3.5 hours. Drainage tray 8, having four 3/32^{nd} inch drainage holes, has a drainage rate of approximately six hours.

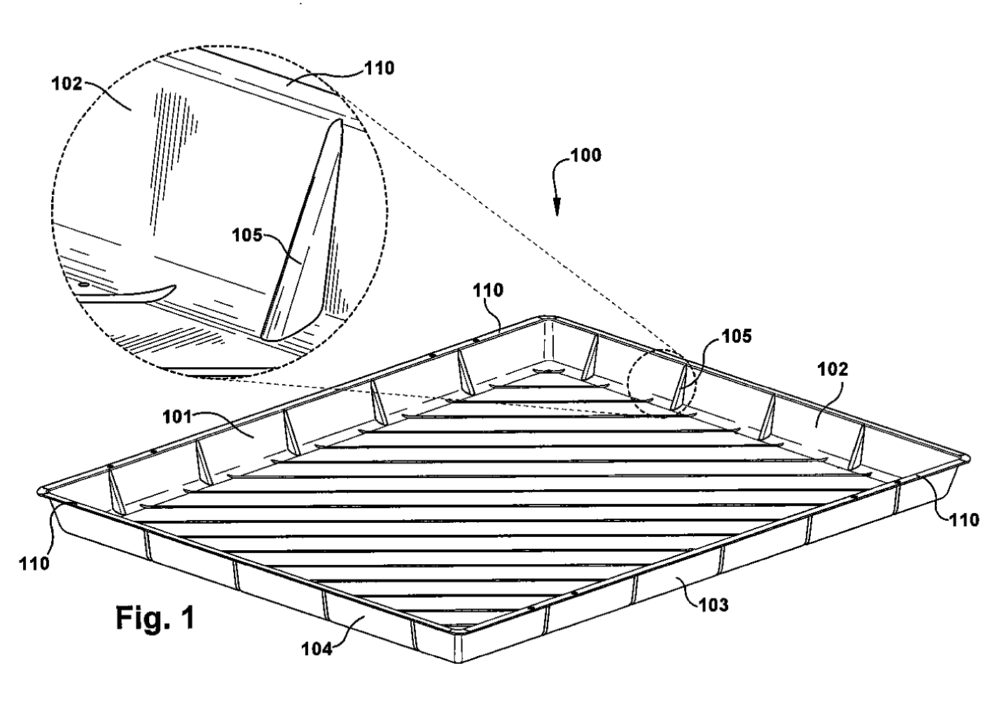

A representative and preferred embodiment of a plant hydration pallet tray 100 is shown in FIG. 1. The plant tray 100 has, in this particular embodiment, the general configuration of a rectangular and generally cubic vessel, with exemplary dimensions of approximately 48 inches length and 40 inches width, and preferably with side walls, 101, 102, 103, 104, arranged perpendicularly and formed integrally with a base, preferably from a suitable plastic material that is suitable for manufacture by a molding process and suitable for use in an outdoor environment, such that it will not easily be damaged by exposure to sun, rain, snow or other weather-related conditions, such as for example but not limited to ABS, polystyrene or polyethylene or alloys thereof The material as molded in the described configurations is also preferably sufficiently strong to accommodate one or more plant pots or containers that are partially or completely filled with soil, potting medium or other material (not shown) for biologically supporting one or more plants (not shown), and preferably weighing approximately 100 lbs. or less. The durable plastic material used to construct the plant tray is preferably 100% recyclable and the plant trays are designed to be stackable or capable of nesting. It is assumed the plants placed on the plant tray will be contained in a pot or other type of container which has at least one opening at the base or general porosity for drainage and to provide for absorption of water by the plant roots. This includes porous and organic material plant containers.

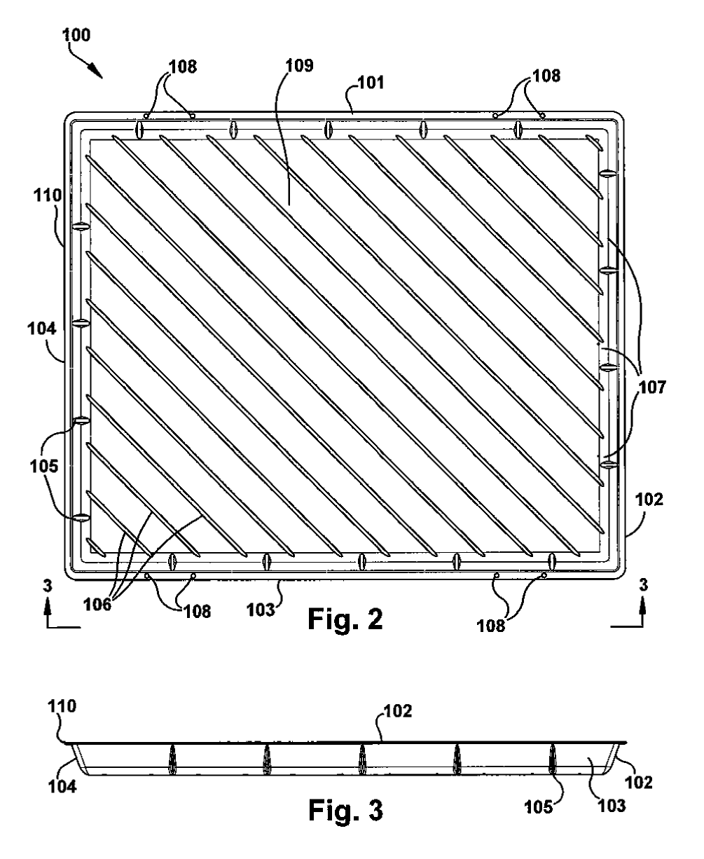

As shown in FIG. 2, the plant tray 100 includes a plurality of ribs 106 formed in a pattern such as diagonally across the base 109. The purpose of the ribbing 106 is to provide strength/reinforcement to the base 109, and to elevate pots placed thereon from the surface of the floor 109. As previously mentioned, the tray 100 is preferably designed to accommodate several potted plants weighing up to 100 lbs. each. In the preferred embodiment, the ribs 106 are oriented generally at a forty-five degree angle with respect to the side walls 101, 102, 103, 104 of the tray 100. A representative height dimension of each rib is approximately 0.074 inches, but can be formed with a higher or lower height or vertical profile as desired.

The four side walls 101, 102, 103, 104 of the preferred embodiment are approximately 2.75 inches high and are positioned at an approximate 110 degree angle with respect to the base 109 of the tray 100. The exemplary 2.75 inch height of the side walls 101, 102, 103, 104 provides (in conjunction with drainage hole number, size and positioning) an optimal drain rate of water through the tray 100, as further described. A tray 100 with the exemplary dimensions of 48 inches long, 40 inches wide, and 2.75 inches high, has a volume of 5,280 cubic inches. Given that one cubic inch is equal to 0.00432900433 gallon, the tray is capable of holding approximately 23 gallons. By varying the height dimension of the side walls 101, 102, 103, 104, the tray 100 can be configured to have an approximate volume for water in a range of 8 to 35 gallons or more.

In some circumstances, such as where one attempts to remove a plant from the tray, it may be necessary to support a plant pot on one or more of the side walls 101, 102, 103, 104 of the base 109. To facilitate such use, the plant tray 100 contains a lip 110 extending outward around the side walls 101, 102, 103, 104 and several gussets 105 positioned between the base 109 and side walls 101, 102, 103, 104 so as to additionally reinforce and maintain the rigidity of the side walls 101, 102, 103, 104, as shown in FIGS. 2 and 3. In a representative embodiment, the lip 110 has a dimension laterally outward from the respective side wall in a range of approximately 0.25 inches to 1.00 inch. In this example, a plurality (such as for example five (5)) gussets 105 placed along the long sides 101, 103 and 4 gussets 105 placed along the short sides 102, 104 of the tray 100 for a total of 18 gussets 105. The gussets 105 are preferably placed at approximately a 9 degree angle with respect to the side walls 101, 102, 103, 104 of the tray 100.

The plant tray 100 of the present disclosure also includes a plurality of drainage holes, such as the three drainage holes 107 depicted in the base 109 to enable and facilitate gravity drainage of water from the tray. The drainage holes 107 allow water to drain from the tray 100 at a controlled and optimal rate, while keeping the roots of the plants proximate to the base 109 saturated and/or submerged so as to avoid dehydration. In the preferred embodiment, the drainage holes 107 are approximately 0.125 inches in diameter and placed on either the left or Tight side of the plant tray 100 approximately 9.5 inches apart. One drainage hole 107 is placed approximately 10.3 inches inward from a corner of the tray 100. The size and placement of the drainage holes 107 are designed to achieve optimal drain rate of the water from the tray 100 so that the plants can continuously absorb water through holes located in the plant pot or container (not shown) for as long as possible. The tray 100 as configured will hold water for a period of time ranging from approximately 3 hours to 6 hours, dependent upon the frequency of watering and ambient atmosphere. The described drain rates may also vary depending upon the number and type of plants placed on the tray 100, and temporary or prolonged blockage of the drainage holes 107, as may occur for example by soil or other object occluding one or more of the drainage holes 107. The watering cycle can range from every day to every three days depending upon the drainage rate or rates and ambient atmospheric conditions. For example, if the temperature is 80 degrees Fahrenheit or below, watering may be required every three days; at temperatures between 80 and 90 degrees Fahrenheit, watering may be required every two days; and at temperatures of 90 degrees Fahrenheit or above, watering may be required every day in order to maintain moisture or saturation of the plant roots and particularly the roots proximate to the tray base 109. The plant tray itself may serve as a watering gauge that is used to determine the frequency of watering.

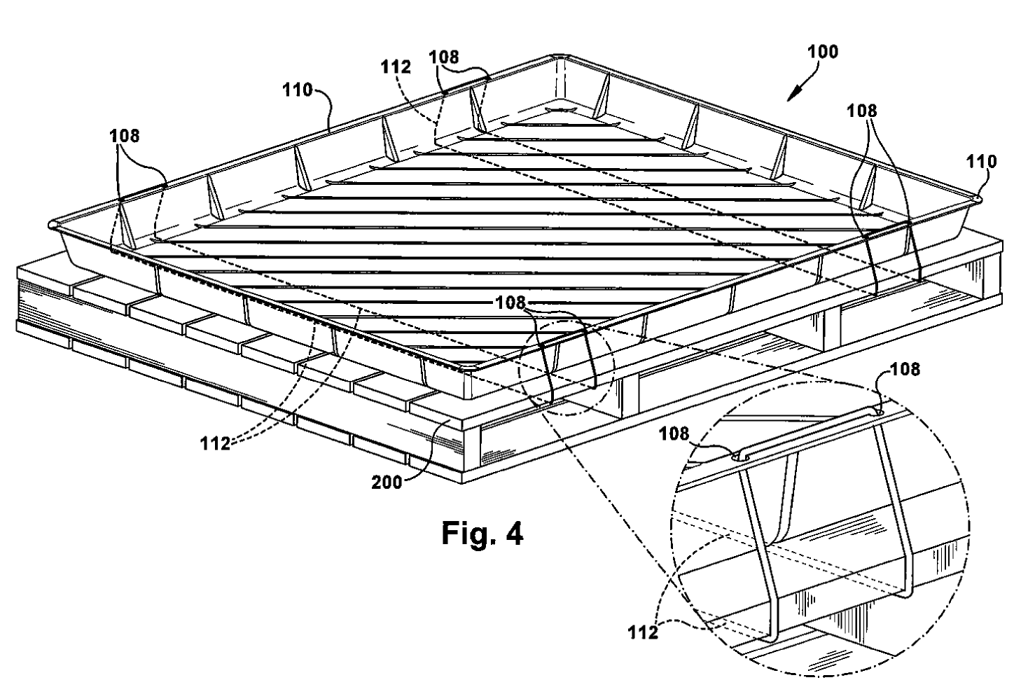

In the preferred embodiment, the lip 110 of the plant tray that runs along each side wall 101, 102, 103, 104, is formed with eight cable holes 108. Four cable holes 108 are located on the lip 110 along one side of the tray 100, and four cable holes 108 are located along an opposite side of the tray 100. As illustrated, the cable holes 108 are preferably placed in pairs, each pair being spaced approximately four inches apart. Other spacing dimensions are possible. In his particular embodiment, the cable holes 108 are located approximately seven inches from the corners of the tray and the distance between the illustrated pairs of holes 108 is approximately fourteen inches. Each cable holes 108 is 0.375 inches in diameter, but can be made smaller or larger within the available area of the lip 110 and the respective adjoining side wall. The cable holes 108 are preferably placed as such so that they may accommodate at least four releasable cable tie straps 112 which can be used to secure the tray to a wood pallet 200, as shown in FIG. 4, or other supporting structure as may be used for handling, transport or display.

Although specific components, materials, configurations and uses of the present invention are illustrated and set forth in this disclosure, it should be understood that a number of variations of the components and to the configuration of those components described herein and in the accompanying figures can be made without changing the scope and function of the invention set forth herein.

1. A plant hydration pallet tray for storing, watering, and transporting potted plants comprising:
a base with four sidewalls arranged perpendicular thereto;
one or more openings in the base configured to drain water therethrough at a defined rate;
one or more ribs arranged diagonally and extending across the base and upward from a top surface of the base;
one or more gussets arranged at an angle between the base and each of the side walls;
a lip that extends laterally outward from a top edge of each side wall;
wherein a drainage rate of the plant tray, when substantially filled with water, is between approximately three hours and approximately six hours.

2. The plant hydration pallet tray of claim 1 comprising two ⅛^{th} inch diameter holes in the base and having a drainage rate of approximately three hours.

3. The plant hydration pallet tray of claim 1 comprising three ⅛^{th} inch diameter holes in the base and having a drainage rate of approximately 3½ hours.

4. The plant hydration pallet tray of claim 1 comprising four 3/32^{nd} inch diameter holes in the base and having a drainage rate of approximately 6 hours.

5. The plant hydration pallet tray of claim 1 having at least four holes in the lip configured to receive a tie fastener for securement of the plant hydration pallet tray to a pallet.

6. The plant hydration pallet tray of claim 1 comprising a volume of approximately 23 gallons.

7. The plant hydration pallet tray of claim 1 in a molded plastic configuration.

8. The plant hydration pallet tray of claim 1 wherein each side wall is capable of withstanding one or more potted plants weighing in total approximately 100 lbs. or less.

9. A generally rectangular plant hydration pallet tray for supporting and maintaining hydration of one or more potted plants placed thereon, the plant hydration pallet tray comprising:
a generally planar and rectangular base which is approximately 48 inches long and 40 inches wide;
a side wall extending upward from each side of the generally planar and rectangular base, each side wall having a vertical extent in a range of approximately 2 inches to 4 inches and oriented at an angle with respect to the base in a range of approximately 90 degress to 120 degrees;
at least three openings in the base configured for drainage of water;
one or more ribs formed in the base and extending generally vertically above the base in a range of between approximately 0.125 inches to 0.875 inches and extending diagonally across the base at an angle with respect to each of the side walls;
one or more gussets positioned between the base and side walls at a nine degree angle with respect to the sidewalls;
a lip which extends laterally outward and generally horizontally from each side wall, the lip extending in a lateral direction to an extent in a range of 0.125 inches to 0.625 inches;
wherein the liquid capacity of the plant tray is between 17 and 33 gallons and a drainage rate approximately 3.5 hours.

10. The plant hydration pallet tray of claim 9 further comprising at least four holes in the lip each for receiving a tie fastener to secure the plant tray to a pallet.

11. The plant hydration pallet tray of claim 9 constructed from a plastic material suitable for being manufactured by a molding process.

12. The plant hydration pallet tray of claim 9 wherein each side wall is capable of withstanding one or more potted plants weighing in total approximately 100 lbs. or less.

13. A generally rectangular and cubic plant hydration pallet tray comprising;
a rectangular base having a first side length of approximately 48 inches and a second side length of approximately 40 inches;
four interconnected side walls, each side wall extending upward from a respective side of the base, each side wall having an approximate height dimension of 2.50 to 3.00 inches and oriented at an angle with respect to the base in a range of approximately 90 degrees to 120 degrees;
a plurality of openings in the base configured to allow drainage of water;
a plurality of fibs formed in the base and which extend generally vertically from the base into an interior volume of the plant hydration pallet tray and extending between the side walls and diagonally across the base;
a plurality of gussets extending between each of the side walls to the base;
a lip that extends laterally outward from each of the side walls;
wherein the liquid capacity of the plant tray is between 21 and 25 gallons and the drainage rate is between three and six hours.

14. The plant hydration pallet tray of claim 13 having at least four holes in the lip of the plant tray that can be used to secure the plant tray to a pallet.

15. The plant hydration pallet tray of claim 13 constructed from a plastic material suitable for being manufactured by a molding process.

16. The plant hydration pallet tray of claim 1 wherein each side wall is capable of withstanding one or more potted plants weighing in total approximately 100 lbs. or less.
